(19) United States
(12) Patent Application Publication
(10) Pub. No.: US 2025/0117484 A1
(43) Pub. Date: Apr. 10, 2025

(54) VALIDATING AND MONITORING MICROSERVICES-BASED ZERO TRUST ENVIRONMENTS

(71) Applicant: Dell Products L.P., Round Rock, TX (US)

(72) Inventors: Vicente J.P. Amorim, João Monlevade (BR); Werner Spolidoro Freund, Rio de Janeiro (BR); Roberto Nery Stelling Neto, Rio de Janeiro (BR); Vítor Nascimento Lourenço, Niterói (BR)

(21) Appl. No.: 18/483,566

(22) Filed: Oct. 10, 2023

(51) Int. Cl. G06F 21/56

(52) U.S. Cl. CPC G06F 21/566; G06F 2221/034

(57) ABSTRACT

Monitoring and validating zero trust systems is disclosed. A monitoring engine, which is external to a zero trust architecture, is configured to instantiate clients based on client specifications. This allows a client to issue a request to a zero trust system and evaluate the response to the request in the context of an expected response. The behavior of the zero trust system can be validated or not validated based on this evaluation.

### FIELD OF THE INVENTION

Embodiments of the present invention generally relate to zero trust architectures and computing systems. More particularly, at least some embodiments of the invention relate to systems, hardware, software, computer-readable media, and methods for validating and monitoring zero trust computing systems.

### BACKGROUND

The concept of a safe network seems to be continually evolving. At one point, a safe network was characterized as a system that protected access to resources using authentication/authorization and the ability to access resources was restricted to use of a virtual private network (VPN). While VPNs continue to provide important security, their traffic is typically confined to a defined perimeter. As more businesses allow their employees to work from home, the security requirements and environments have changed. In these situations, even when a VPN is used, resources may be exposed to external agents.

One way to address these perceived weaknesses is to use a zero trust architecture (ZTA). A ZTA, generally stated, is configured to ensure that users, applications, resources, and actions in a computing system are authorized or approved. In ZTAs, there is zero trust and trust is generally not remembered. For example, users or applications are authenticated each time an action is performed, each time access is requested, and the like. For example, a user may be authorized or authenticated each time a resource is accessed. This is distinct from authenticating the user initially and then continually granting access to the resources.

The operation of a ZTA is not limited to authenticating users. For example, a ZTA may be self-vigilant and may continuously validate and monitor the behavior of its assets/resources. A ZTA, for example, should be aware of the internal states of its services or other resources (its assets). The ZTA should monitor or ensure that services are up and running. The ZTA should ensure that responses to requests conform to the requirements of the ZTA.

Unfortunately, monitoring this behavior can be onerous. Monitoring and validating these behaviors can be intrusive and may result in architecture modifications. These modifications may result in an increased attack surface, which may require additional efforts to maintain the ZTA. Further, monitoring and validating these behaviors generate additional processing and communication overhead. Thus, the ZTA must provide those resources or risk impacting the user experience in a negative manner. In essence, ZTAs are often faced with a problem referred to as the continuous monitoring and validation problem.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1 discloses aspects of a monitoring engine configured to monitor and/or validate behaviors of a zero trust architecture or system;

FIG. 2 discloses additional aspects of a monitoring engine configured to monitor and/or validate aspects of a zero trust architecture or system;

FIG. 3 discloses aspects of a specification or client file used by the monitoring engine to monitor and/or observe the behavior or operation of a zero trust architecture or system;

FIG. 4 discloses aspects of a method for monitoring and/or observing the behavior of a zero trust architecture;

FIG. 5 discloses aspects of an example in which behavior of a zero trust architecture is monitored and/or validated; and

FIG. 6 discloses aspects of a computing entity, system, or device.

### DETAILED DESCRIPTION OF SOME EXAMPLE EMBODIMENTS

Embodiments of the present invention generally relate to zero trust architectures (ZTAs) or zero trust computing systems that aim to comply with zero trust requirements, which may include but are not limited to a policy decision point and a policy enforcement point. More particularly, at least some embodiments of the invention relate to systems, hardware, software, computer-readable media, and methods for monitoring and/or validating the behaviors and/or behavior dynamics of service (microservice)-based zero trust architectures.

A ZTA, which is a computing infrastructure that follows zero trust requirements in one example, may be configured to continuously verify activity (or other behaviors) in the ZTA, including network activity. In ZTAs, trust is never granted implicitly.

Embodiments of the invention relate to a framework or system (e.g., a monitoring engine) that is configured to perform zero trust operations to monitor and verify aspects of the behavior of a ZTA. The monitoring engine may perform zero trust operations including, but not limited to, monitoring network behavior, validating network behavior, monitoring and/or validating requests and responses to those requests. The monitoring engine may be external to the zero trust architecture or operate externally with respect to the zero trust architecture.

In one example, the monitoring engine may be configured to autonomously interact with services or microservices-based ZTAs. The monitoring engine may issue requests to resources (e.g., microservices) of the ZTA and analyze the responses to those requests. This allows the monitoring engine to determine whether the behavior of the ZTA (or of the underlying system being protected) is expected or whether the behavior of the ZTA (or the underlying system being protected) is anomalous or unexpected. The monitoring operation may also consider telemetry information and data from other monitoring/observing components of the ZTA.

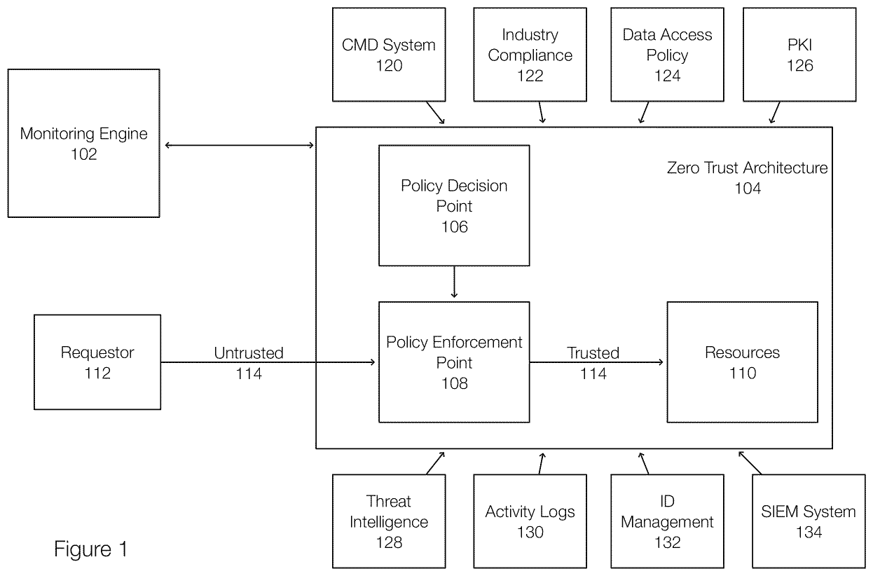

FIG. 1 discloses aspects of a monitoring engine configured to monitor, observe, test, and/or validate network behavior, behavior of the zero trust architecture, or the like. The monitoring engine is an example of a framework that is configured to interact with a services-based zero trust architecture and to monitor behaviors associated therewith.

FIG. 1 illustrates a zero trust architecture 104 that includes a policy decision point 106, which may operate in a control plane, and a policy enforcement point 108, which may operate in a data plane. In this example, a requestor may generate a request, which is untrusted 114 initially (thus demonstrating that nothing is implicitly trusted in the ZTA 104), that is received at a policy enforcement point 108. The policy enforcement point 108 may be configured to enable, monitor, terminate, etc., connections between the requestor 112 and resources 110 in or protected by the zero trust architecture 104. The policy enforcement point 108 may enforce policy decisions made by the policy decision point 106.

More specifically, the policy decision point 106 may include a policy engine and a policy administrator. The policy engine may be responsible for deciding whether to grant the requestor 122 access to the resources 110 (or a specific resource).

The policy decision point 106 may rely on input from external sources. The input from the external sources may be used to make decisions on granting access to resources. For example, a CDM (Continuous Diagnostics and Mitigation) system 120 may gather information about the state of the assets (e.g., the resources), apply updates to configurations and software components, and the like. The CDM system 120, for example, may inform the policy decision point 106 about whether a requestor making an access request is running the appropriate operating system (e.g., all patches applied), whether the requestor has known vulnerabilities or the like. Industry compliance 122 ensures that the architecture 104 is compliant with regulations (e.g., healthcare regulations, financial regulations). The threat intelligence 128 may provide information related to attacks, newly discovered attacks, patches, newly identifies malicious components, or the like. The activity logs 130 may aggregate logs, network traffic to generate information on the security of the system. The public key infrastructure (PKI 126) may be responsible for generating and logging the relevant certificates. The ID management 132 may be responsible for creating, storing, and managing user accounts and identity records. The security information and event management (SIEM system 134) may collect information for analysis and may aid in refining policies, warn of potential attacks, or the like. This is more fully described in NIST Special Publication 800-207, Zero Trust Architecture at https://doi.org/10.6028/NIST.SP.800-207, which is incorporated by reference in its entirety.

The monitoring engine 102 is an example of a system or framework that is configured to monitor the behavior of aspects of the zero trust architecture 104. The monitoring engine 102 may include or be associated with processors, memory, networking hardware, and the like. In this example, the monitoring engine 102 is configured to perform monitoring and validating autonomously in a ZTA such as a services-based ZTA. The monitoring engine 102 may be configured to continuously monitor components (e.g., at least resources 110 and network behavior) of the zero trust architecture 104. The monitoring engine 102 may also be implemented as an independent and external framework from the perspective of the ZTA 104. This allows the monitoring engine 102 to be reusable across multiple networks and integrated into other environments, such as CI/CD environments in order to achieve zero trust compliant DevSecOps practices.

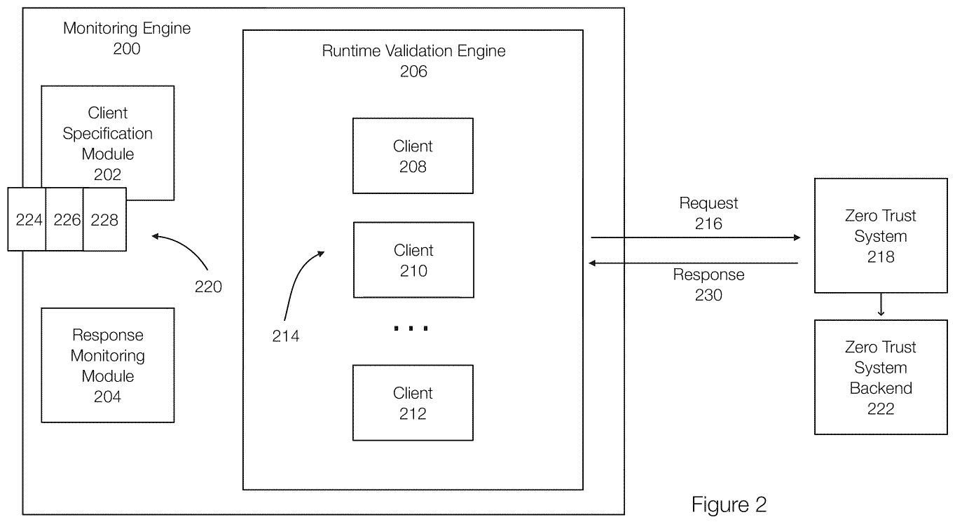

FIG. 2 discloses aspects of a monitoring engine. The monitoring engine 200 may be external to and independent of a zero trust system 218, which is an example of the ZTA 104. The monitoring engine 200 includes various engines or modules that are configured to monitor behavior of a backend 222 (e.g., microservices or other resources) of the zero trust system 218 in one example.

In the monitoring engine 206, a runtime validation engine 206 may include various clients, represented by clients 208, 210, and 212. Clients can be instantiated to run in the runtime validation engine 206. The runtime validation engine 206 may be associated with a client specification module 202 that may include or be associated with client specifications 220 or client files. The interaction logic between the monitoring engine 200 (or the clients executing in the runtime validation engine 206) and the zero trust system 218 may be specified in the specifications 220.

The client specification module 202 may include multiple specifications 220, which may be associated with multiple clients or other entities. For example, the clients 208, 210, and 212 are associated with, respectively, specifications 224, 226, and 228. The individual specifications 220 can be executed individually, concurrently or simultaneously with other specifications, repeatedly, or the like.

The runtime validation engine 206, when executing a client 208 which may have an associated specification 224, may parse and execute the specification 224. Using a formal language or syntax to create the specifications 220, in one example, the actions (e.g., requests) that the runtime validation engine 206 is to perform may be specified in the corresponding client specification.

In one example, the specifications 220, when executed by the runtime validation engine 206, cause the clients instantiated in the runtime validation engine 206 to issue one or more requests. Each of these requests is associated with an expected response. For example, a request 216 is issued by the runtime validation engine 206 (or by a specific client) and a response 230 is received by the runtime validation engine 206. By comparing the response 230 actually received from the ZTA 218 with the expected response set forth in the specification 224, the monitoring engine 200 has the ability to validate each interaction and thus monitor and observe the behavior of the zero trust system 218 including the backend 222 (e.g., microservices).

More specifically, the responses (230) to the requests (216) are evaluated by the response monitoring module 204, which may monitor the response in real or near real time. By verifying the responses received in answer to the requests, the response monitoring module 204 can verify microservices and internal dynamics of the zero trust system 218. This allows the response monitoring module 204 to recurrently perform these monitoring operations.

For example, the response monitoring module 204 may be configured to verify that the responses comply with the expected responses, which may be set forth in the specifications 220, check status, validity, and integrity of the backend 222, and verify that policies of the zero trust system 218 are followed.

Each of the clients 208, 210, and 212 can be programmed to perform actions in a generic manner and adapt to various and different types of zero trust systems. By repeatedly executing a client, in accordance with the corresponding specification 220, changes in behavior of the zero trust system 218 or its assets can be identified quickly. Embodiments of the invention may, in addition to validating the responses using the corresponding specifications, compare a current response to historical responses, verify telemetry data with respect to expected and/or historical telemetry data, and the like.

More specifically, the client specification module 202 may be a repository for specifications 220 that describe behavior of the ZTA and/or its resources or assets. The clients 208, 210, and 212 are representative of a physical user/device and are flexible. The behavior of the clients 208, 210, and 212 can be specified. The specifications 220 may each describe the manner in which an independent or autonomous client may act. Thus, the specifications 220 (or client files) are consumed and instantiated by the runtime validation engine 206 as the clients 208, 210, and 212. The specifications 220 may be specified in a markup language (e.g., XML, JSON) to describe the actions to perform and the expected responses.

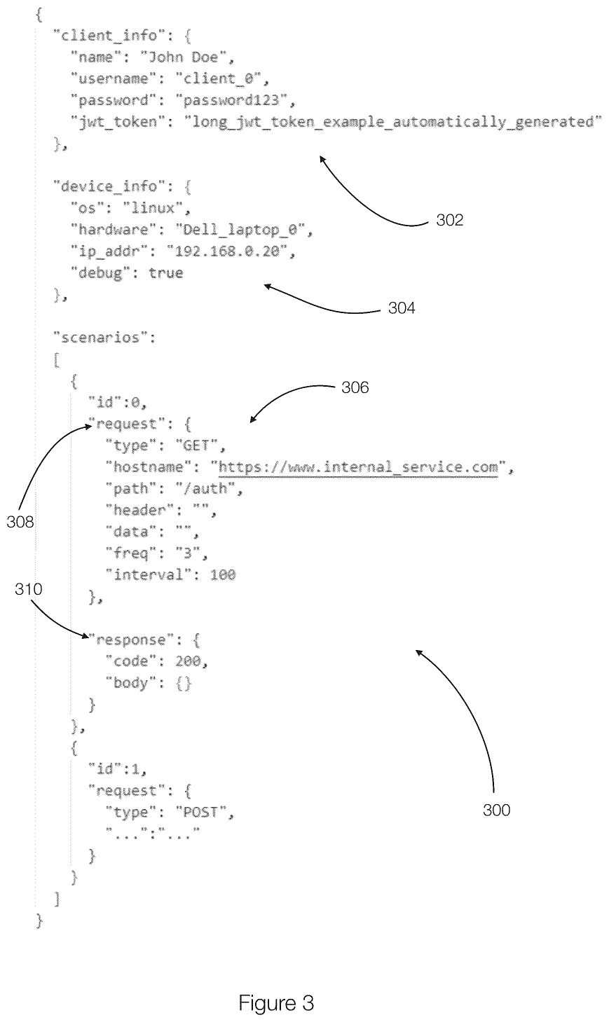

FIG. 3 discloses aspects of an example of a specification or a client file. The specification 300 includes client information 302, which may include authentication information. This allows the client, once executed by the runtime validation engine 206, to perform actions including authentication operations like a typical client. The specification may include device information 304 such as device such as IP address, hardware, and operating system. The scenarios 306 of the specification 300 describe requests that may be performed by the client corresponding to the specification 300 in the runtime validation engine 206 and the expected responses to those requests.

The various fields in the specification 300 can be added, removed, or edited according to context and desired behavior. The specification 300, in this example, include the client information 302 and the device information 304 to better define the operating environment for the request in the scenario 306. The specification 300, when executed, may be associated with logs that are generated by the monitoring engine.

The scenario 306, as previously stated, is configured to list or identify the requests (or actions) to be performed and the expected responses for those requests. For example, the request field 308 of the scenario 306 may include information about the target hostname, the target path, and the frequency and interval at which the request 308 should be performed or issued by the runtime validation engine 206. The response 310 expected for the request 308 is also specified. The responses 310, by way of example, may be defined or described as a pattern, an expression, or the like.

The runtime validation engine 206, by interpreting the specifications 220, can instantiate and run the clients 208, 210, and 212. The runtime validation engine 206 may manage lifecycles of the clients 208, 210, and 212, provide sufficient resources to ensure that the scenarios in the specification can be performed, and the like. Even if the specification 224 is a static representation of the behavior of the client 208, the runtime validation engine 206 can create a dynamic representation on the fly.

Once the clients 208, 210, and 212 are running, the runtime validation engine 206 (or clients) may issue the requests set forth in the corresponding specifications to the backend 222 and collect the responses. The responses may be provided to the response monitoring module 204. The response monitoring module 204 thus receives the responses (and/or logs generated by the runtime validation engine 206). The response monitoring module 204 may be configured as a repository where captured data (e.g., the responses and logs) can be analyzed, exported, or provided to other analytic tools and systems.

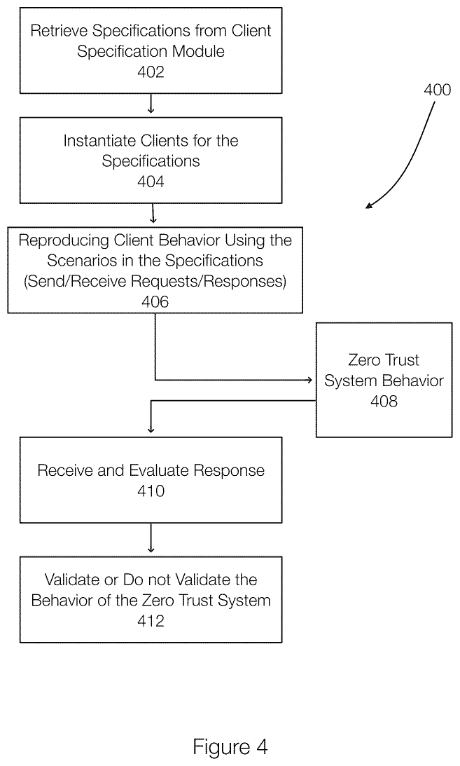

FIG. 4 discloses aspects of a method for monitoring a zero trust system. The method 400 includes retrieving 402 specifications from a client specification module 202. The clients for the retrieved specifications may be instantiated 404. Instantiating 404 the clients may include allocating the required resources. The clients are thus examples of clients that are using the ZTA and are simply clients from the perspective of the ZTA in one example. For example, if the ZTA requires information about the client's operating system, this information may be specified in the client's specification and can be returned. The specifications may allow the clients instantiated by the runtime validation engine to be perceived as real clients.

For each instantiated client, the monitoring engine (or the runtime validation engine) may reproduce 406 a client's behavior by traversing the scenarios (requests/responses) in the client's specification and then send/receive the requests/responses to/from the ZTA backend.

The monitoring engine is agnostic on how it receives and handles the requests/responses. More specifically, identities, policies, and the like pertain to the ZTA—not to the monitoring engine in one example. In other words, the ZTA simply operates or exhibits behavior 408 in response to a request from a client. If a request is legitimate, access may be given by the ZTA to reach an internal resource, such as a microservice. The ZTA may collect telemetry data related to the request from the monitoring engine.

A response is generated and issued by the ZTA (and/or the microservice) and returned to the monitoring engine. Thus, the monitoring engine may receive and/or evaluate 410 the response. Using the response, the monitoring engine (or other analytical tool) may validate or not validate 412 the behavior of the ZTA. The method 400 may be repeated at different times, periodically, continually, or the like.

By controlling client behavior, using the specifications, and recurrently instantiating the clients, the monitoring engine can supply or provide a continuous monitoring environment and validate that the ZTA or assets are working properly. Further, the monitoring engine does not require any changes to the ZTA itself and is agnostic to the components used by the ZTA when enforcing zero trust principles.

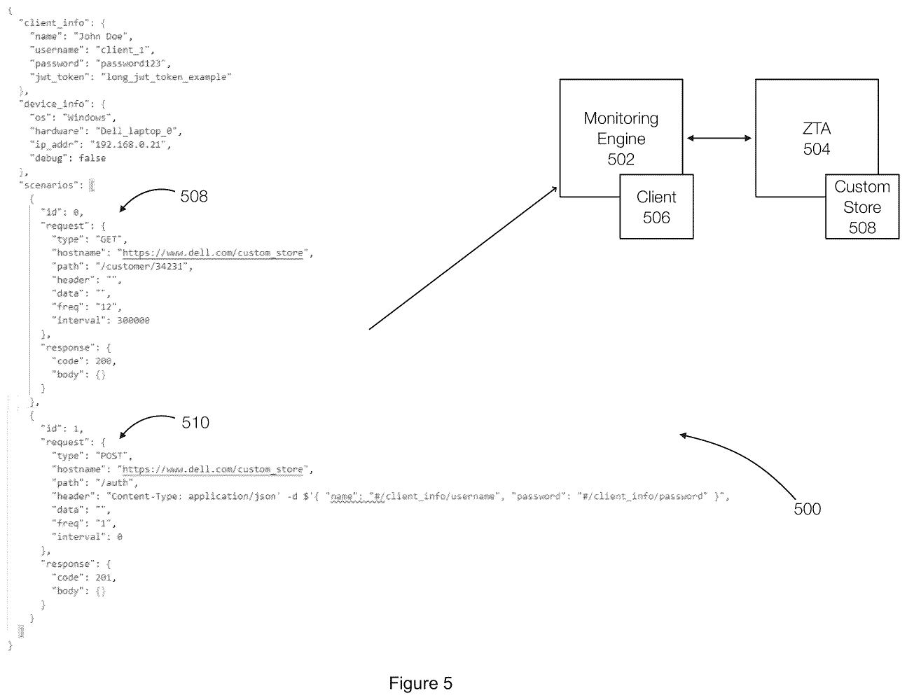

FIG. 5 discloses aspects of an example of monitoring and/or validating a zero trust architecture. FIG. 5 is described in the context of a ZTA with assets that include microservices. The monitoring engine is deployed independently of the ZTA and executed. When executed, the monitoring engine may instantiate and run all existing clients in order to reproduce their inner behavior.

FIG. 5 illustrates a monitoring engine 502 that instantiates a client 506 that is based on a specification 500. In this example, the ZTA 504 includes a service named “custom_store” (custom store 508) that is running in the ZTA 504. The custom store 508 may be a service or a microservice and is part of the backend or assets of the ZTA 504. This service (custom store 508) has the following endpoints:

### Endpoint 1:

www.dell.com/custom_store/customer/<id>
Description: List information about the customer given by <id>.

### Endpoint 2:

www.dell.com/custom_store/auth
Description: Authenticate the user.

The runtime validation engine of the monitoring engine 502 may query the client specification module to retrieve the specification 500. The client 506 is then instantiated and the scenarios in the specification 500 are performed. In this example, the following actions will take place.

The monitoring engine will run the scenario 508, whose scenario ID is 0. In the scenario 508, the values of “freq=12” and “interval=300000” are provided as frequency and interval attributes. This indicates that, during 1 hour and at every 5 min, the runtime validation engine (or the monitoring engine) will:
Execute a request operation (GET) on the hostname+path: https://www.dell.com/custom_store/customer/34231, aiming to have details about the customer id 34231;
Compare the received response code/body against the one described by “code”/“body” attributes within “response” field; and
Send the logs and comparison results to a response monitoring module for further analysis or ingestion by another tool, such as a dashboard or analytics software.

For a second scenario 510, whose ID is 1, the values of the frequency and interval attributes are “freq=1” and “interval=0”. Thus, the runtime validation engine will perform, a single time:
Execute a request operation (POST) on the hostname+path: https://www.dell.com/custom_store/auth, aiming to authenticate the user listed by “client_info” section. In this example, the authentication data is sent directly on the request header;
Compare the received response code/body against the one described by “code”/“body” attributes within “response” field; and
Send the logs and comparison result to response monitoring module for further analysis or ingestion by another tool, such as a dashboard or analytics software.

The example of FIG. 5 illustrates or outlines how client behavior can be reproduced by a monitoring engine and emulate a real user/device interacting with the existing ZTA 504.

In some examples, validating the response may be performed by comparing the expected value against the received value coming from ZTA (as a response to a request). However, there is also a kind of implicit validation occurring because the monitoring engine may also help determine whether other ZTA components are working as expected or not.

For example, to validate that the “ID Management” part or component of the ZTA is available and behaving properly, a client can be configured to issue a request to a service endpoint that expects authentication. The output obtained by the runtime validation engine allows the monitoring engine to determine whether the ID Management component is working properly.

To validate the “Data Access Policy” part or component of the ZTA, a client instantiated in the monitoring engine (with limited access grants) may request access to a service running outside the scope of current policy. Analogously, the answer or response can be used to verify if this ZTA internal block has performed as expected.

Similarly, authorization, anomalous behaviors, Public Key Interface (PKI), and other ZTA inner components can be validated. By aggregating the output of those steps, it is possible to ensure the whole ZTA system or architecture is working as expected.

As the client files represent real users/devices behavior, the continuous monitoring of a ZTA can be reached when the runtime validation engine re-instantiates and re-executes the existing clients. Thus, from time to time, every service and every internal component can be monitored, validated, and/or revalidated as described herein.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods, processes, and operations, are defined as being computer-implemented.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, monitoring operations, zero trust related operations, validation operations, or the like. More generally, the scope of the invention embraces any operating environment in which the disclosed concepts may be useful.

At least some embodiments of the invention provide for the implementation of the disclosed functionality in existing backup platforms, examples of which include the Dell-EMC NetWorker and Avamar platforms and associated backup software, and storage environments such as the Dell-EMC DataDomain storage environment. In general, however, the scope of the invention is not limited to any particular data backup platform or data storage environment. Embodiments of the invention are not limited to data backup platforms, buy may be used in any infrastructure in which zero trust principles are implemented. Further, embodiments may also be implemented outside of zero trust systems to simply monitor/validate the operation of various services, components, modules, or the like.

New and/or modified data collected and/or generated in connection with some embodiments, may be stored in a data storage environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to service read, write, delete, backup, restore, and/or cloning, operations initiated by one or more clients or other elements of the operating environment.

Example cloud computing environments, which may or may not be public, include storage environments that may provide data protection functionality for one or more clients. Another example of a cloud computing environment is one in which processing, data protection, and other services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, containers, or virtual machines (VMs).

Particularly, devices, engines, or the like in the operating environment may take the form of software, physical machines, containers, or VMs, or any combination of these, though no particular device implementation or configuration is required for any embodiment. Similarly, data storage system components such as databases, storage servers, storage volumes (LUNs), storage disks, replication services, backup servers, restore servers, backup clients, and restore clients, for example, may likewise take the form of software, physical machines containers, or virtual machines (VM), though no particular component implementation is required for any embodiment.

Example embodiments of the invention are applicable to any system capable of storing and handling various types of objects or data, in analog, digital, or other form.

It is noted with respect to the disclosed methods, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments of the invention. These are presented only by way of example and are not intended to limit the scope of the invention in any way.

Embodiment 1. A method, comprising: instantiating a client in a runtime validation engine associated with a monitoring engine, wherein the client is configured to emulate a behavior of a real client, generating a request by or associated with the client, sending the request to a computing system, receiving a response to the request sent to the computing system, and evaluating the response to validate or not validate a behavior of the computing system.

Embodiment 2. The method of embodiment 1, further comprising retrieving a specification from a client specification module, wherein the specification includes scenarios including a scenario that defines the request to be generated and sent to the zero trust system.

Embodiment 3. The method of embodiment 1 and/or 2, wherein the scenario includes an expected response to the request.

Embodiment 4. The method of embodiment 1, 2, and/or 3, further comprising comparing the response to the expected response, wherein the behavior is validated when the response conforms to the expected response and wherein the behavior is not validated when the response does not conform to the expected response.

Embodiment 5. The method of embodiment 1, 2, 3, and/or 4, wherein the computing system comprises a zero trust system that is configured to comply zero trust requirements, wherein the zero trust requirements include at least a policy decision point and a policy enforcement point, wherein evaluating the response to validate or not validate a behavior of the computing system further comprises validating or not validating one or more behaviors of the computing system as a whole and/or any components or modules of the computing system.

Embodiment 6. The method of embodiment 1, 2, 3, 4, and/or 5, further comprising recurrently instantiating the client and executing scenarios in the specification that define requests and expected responses to the requests for the client in order to continuously monitor and/or validate the behavior of the zero trust system.

Embodiment 7. The method of embodiment 1, 2, 3, 4, 5, and/or 6, wherein the specification includes attributes, the attributes including at least one or more of a frequency, an interval, and a specific dependency of previous responses.

Embodiment 8. The method of embodiment 1, 2, 3, 4, 5, 6, and/or 7, wherein the specification allows the monitoring engine to interpret the specification and create a dynamic representation on the fly of the client.

Embodiment 9. The method of embodiment 1, 2, 3, 4, 5, 6, 7, and/or 8, wherein the behavior of the zero trust system is validated or not validated based on the response and/or logs generated by the runtime validation engine using a response monitoring engine.

Embodiment 10. The method of embodiment 1, 2, 3, 4, 5, 6, 7, 8, and/or 9, wherein the zero trust system is a microservices based zero trust system.

Embodiment 11. The method of embodiment 1, 2, 3, 4, 5, 6, 7, 8, 9, and/or 10, wherein the monitoring engine is external and independent of the zero trust system.

Embodiment 12. A system, comprising hardware and/or software, operable to perform any of the operations, methods, or processes, or any portion of any of these, disclosed herein.

Embodiment 13. A non-transitory storage medium having stored therein instructions that are executable by one or more hardware processors to perform operations comprising the operations of any one or more of embodiments 1-11.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general-purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, agent, client, engine, service, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

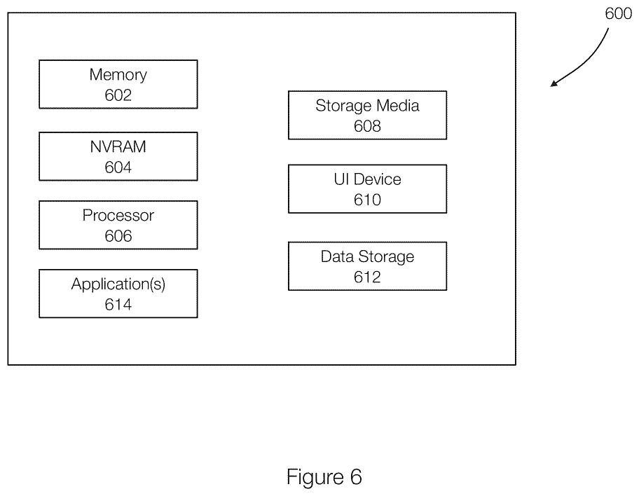

With reference briefly now to FIG. 6, any one or more of the entities disclosed, or implied, by the Figures and/or elsewhere herein, may take the form of, or include, or be implemented on, or hosted by, a physical computing device, one example of which is denoted at 600. As well, where any of the aforementioned elements comprise or consist of a virtual machine (VM), that VM may constitute a virtualization of any combination of the physical components disclosed in FIG. 6.

In the example of FIG. 6, the physical computing device 600 includes a memory 602 which may include one, some, or all, of random access memory (RAM), non-volatile memory (NVM) 604 such as NVRAM for example, read-only memory (ROM), and persistent memory, one or more hardware processors 606, non-transitory storage media 608, UI device 610, and data storage 612. One or more of the memory components 602 of the physical computing device 600 may take the form of solid-state device (SSD) storage. As well, one or more applications 614 may be provided that comprise instructions executable by one or more hardware processors 606 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
instantiating a client in a runtime validation engine associated with a monitoring engine, wherein the client is configured to emulate a behavior of a real client;
generating a request by or associated with the client;
sending the request to a computing system;
receiving a response to the request sent to the computing system; and
evaluating the response to validate or not validate a behavior of the computing system.

2. The method of claim 1, further comprising retrieving a specification from a client specification module, wherein the specification includes scenarios including a scenario that defines the request to be generated and sent to the zero trust system, wherein the scenario includes an expected response to the request.

3. The method of claim 2, further comprising comparing the response to the expected response, wherein the behavior is validated when the response conforms to the expected response and wherein the behavior is not validated when the response does not conform to the expected response.

4. The method of claim 1, wherein the computing system comprises a zero trust system that is configured to comply with zero trust requirements, wherein the zero trust requirements include at least a policy decision point and a policy enforcement point, wherein evaluating the response to validate or not validate a behavior of the computing system further comprises validating or not validating one or more behaviors of the computing system as a whole and/or any components or modules of the computing system.

5. The method of claim 1, further comprising recurrently instantiating the client and executing scenarios in the specification that define requests and expected responses to the requests for the client in order to continuously monitor and/or validate the behavior of the zero trust system (and/or its components).

6. The method of claim 1, wherein the specification includes attributes that may control the behavior and nature of a request, the attributes including at least one or more of a frequency, an interval, and a specific dependency of previous responses.

7. The method of claim 1, wherein the specification allows the monitoring engine to interpret the specification and create a dynamic representation on the fly of the client.

8. The method of claim 1, wherein the behavior of the zero trust system is validated or not validated based on the response and/or logs generated by the runtime validation engine using a response monitoring engine.

9. The method of claim 1, wherein the zero trust system is a microservices based zero trust system.

10. The method of claim 1, wherein the monitoring engine is external and independent of the zero trust system.

11. A non-transitory storage medium having stored therein instructions that are executable by one or more hardware processors to perform operations comprising:
instantiating a client in a runtime validation engine associated with a monitoring engine, wherein the client is configured to emulate a behavior of a real client;
generating a request by or associated with the client;
sending the request to a zero trust system;
receiving a response to the request form the zero trust system; and
evaluating the response to validate or not validate a behavior of the zero trust system.

12. The non-transitory storage medium of claim 11, further comprising retrieving a specification from a client specification module, wherein the specification includes scenarios including a scenario that defines the request to be generated and sent to the zero trust system.

13. The non-transitory storage medium of claim 12, wherein the scenario includes an expected response to the request.

14. The non-transitory storage medium of claim 13, further comprising comparing the response to the expected response, wherein the behavior is validated when the response conforms to the expected response and wherein the behavior is not validated when the response does not conform to the expected response.

15. The non-transitory storage medium of claim 11, further comprising recurrently instantiating the client and executing scenarios in the specification that define requests and expected responses to the requests for the client in order to continuously monitor and/or validate the behavior of the zero trust system.

16. The non-transitory storage medium of claim 11, wherein the specification includes attributes, the attributes including at least one or more of a frequency, an interval, and a specific dependency of previous responses.

17. The non-transitory storage medium of claim 11, wherein the specification allows the monitoring engine to interpret the specification and create a dynamic representation on the fly of the client.

18. The non-transitory storage medium of claim 11, wherein the behavior of the zero trust system is validated or not validated based on the response and/or logs generated by the runtime validation engine using a response monitoring engine.

19. The non-transitory storage medium of claim 11, wherein the zero trust system is a microservices based zero trust system.

20. The non-transitory storage medium of claim 11, wherein the monitoring engine is external and independent of the zero trust system.
